(19) United States
(12) Patent Application Publication
(10) Pub. No.: US 2007/0179662 A1
(43) Pub. Date: Aug. 2, 2007

(54) Apparatus for inspecting food items

(76) Inventors: Vidar Erlingsson, Gardabaer (IS); Hrafnkell Eiriksson, Kopavogur (IS); Kristinn Andersen, Hafnarfjordur (IS)

Correspondence Address: NIXON & VANDERHYE, PC, 901 NORTH GLEBE ROAD, 11TH FLOOR, ARLINGTON, VA, 22203, US

(21) Appl. No.: 10/593,290

(22) PCT Filed: Mar. 10, 2005
(86) PCT No.: PCT/IS05/00007

§ 371 Date: Sep. 18, 2006

(30) Foreign Application Priority Data
Mar. 19, 2004 (IS) 7191

(51) Int. Cl. B29C 45/00

(52) U.S. Cl. 700/200

(57) ABSTRACT

An apparatus for the inspection of food items, in particular inspection for bones or bone fragments in boneless or de-boned meat or fish products, is provided. The apparatus comprises means for forming the food items into a shape of substantially uniform thickness prior to and/or during image analysis using X-ray emission and detection means. By forming the food items to substantially uniform thickness, image analysis for the detection of bones and bone fragments is enhanced due to the removal of background variations. A method for inspection of food items and the use of an X-ray apparatus in such applications is also provided.

### INTRODUCTION

The present invention relates to an apparatus for the inspection of food items, or a stream of food material, in particular with respect to the inspection for bones or bone fragments in boneless or de-boned meat or fish products, but also to the inspection for other undesired materials, such as pieces of wood, plastic, glass or metal. The apparatus comprises means for forming the food items into a shape of substantially uniform thickness prior to and/or during image acquisition using X-ray emission and detection means. Such forming of the food items to substantially uniform thickness enhances the image analysis performance for the detection of bones and bone fragments. The present invention furthermore relates to a method for inspection of food items and the use of an X-ray apparatus in such applications.

### BACKGROUND OF THE INVENTION

In many applications in food processing, de-boned or boneless food products are formed or used. Typical applications include de-boning of selected pieces of chicken meat, including breast and thigh meat, de-boning of fish and fish fillets, as well as de-boning of various other sources of meat, including beef and veal. It is of great importance, both from a safety point of view and a quality assurance point of view, that such food items are completely boneless, since residual bone or bone fragments may be unappetizing or even harmful to the customer.

Present de-boning techniques cannot guarantee that the de-boned product is completely free of residual bones or bone fragments, and as a consequence it is essential to quality control de-boned or boneless food products by inspecting the individual food items for residual bone or bone fragments. Various techniques have been utilized for this purpose. For example, in the fish industry, the use of illumination tabletops is common for detecting bones in fish fillets. A light source under the tabletop is used to light up the fish fillets, and a human operator inspects the fillets for the presence of residual bones.

In the meat industry, the use of X-ray apparatus for the analysis of food items has been used. In such analysis, X-ray emission and detection means are used to inspect the non-transparent (to the human eye) food items, and conventional image acquisition, followed by image analysis, is used to decipher the images obtained for the presence of bones or bone fragments.

There are several problems associated with this type of analysis. Although bones in general absorb X-rays to a larger degree than the surrounding tissue, in certain meat products, such as chicken, the absorption can be comparable. In such cases, the similarity of X-ray absorption in bone and muscle can make the detection of bones in the muscle tissue difficult. This problem is even greater when small bone fragments, which may be harmful to the customer, are present in the de-boned or boneless muscle. A further problem is associated with the fact that the food items being inspected are typically not of uniform composition or thickness. As a consequence, the absorption of emitted X-rays and therefore the contrast of the analysis, is non-uniform, which can greatly interfere with the analysis.

In U.S. Pat. No. 3,995,164 a method and apparatus for the detection of foreign material in food substances is disclosed. Bones are detected in chicken portions by sensing changes in transmitted X-ray signals while portions are immersed in water.

In U.S. Pat. No. 6,023,497 imaging processing is used to detect foreign matter in food products. Calculations are performed within kernels of a fixed size, and a weighted average over the kernel is calculated. A difference calculation between X-ray intensity of a target pixel and the weighted average of the kernel of the target pixel is used to determine if a contaminant in the product is present.

An apparatus for use in mammography is disclosed in U.S. Pat. No. 4,090,084. The apparatus includes a pressure plate, which is used to apply uniform pressure to the entire breast being inspected, so as to obtain a collimated optimal X-ray picture

Furthermore, US 2003/0167004 discloses a mammography method and apparatus for detecting cancers in breast tissue, wherein the method involves applying pressure to the anterior surface of the breast with compression paddles. A three-dimensional image of the compressed breast is obtained by combining images obtained by ultrasound and by X-ray detection.

U.S. Pat. No. 5,847,382 disclose an apparatus for detecting bone fragments and other defects in de-boned material. The apparatus has a video camera for obtaining images of transmitted light from flattened de-boned meat products, and projects the image of the meat product on a monitor which is observed by an operator.

### DESCRIPTION OF THE INVENTION

The present invention provides means for detecting bones, bone fragments or other undesired materials, such as pieces of wood, plastic, glass or metal in food items by a surprisingly advantageous apparatus. The apparatus includes means for generating substantially uniform X-ray attenuation image of food items arriving by a conveying means by forming the food items into a shape of substantially uniform thickness prior to and/or during image acquisition using X-ray emission, and subsequent image analysis. The apparatus may furthermore include means for automatically displacing items deemed to contain bones, bone fragments or other undesired materials, or means for registering their location for further processing or action. By combining X-ray imaging, image analysis and advantages derived from forming the food items into shapes of substantially uniform thickness while collecting X-ray images, a unique apparatus and method for detecting bones and bone fragments in food items is obtained.

Definitions

In the present context, the term “food item” can refer to any food item produced or processed in a food production line. Food items can include de-boned or boneless pieces of fish or meat, such as beef, veal, lamb, chicken or turkey meat. The food items may also be comprised of a stream of food, such as ground food or other small food items that are conveniently conveyed in a stream.

The term “means for forming the food items into a shape of substantially uniform thickness” refers to mechanical means for forming items such as food items. Such means may, as discussed herein, be comprised of one or several rollers or a stationary means, across which a belt may be stretched. Many additional variations of mechanical means for forming of food items being conveyed under the means are possible, and thus also fall under this definition.

The term “X-ray image data” refers to any data collected by an X-ray sensor, including data representing complete or partial images of items passing through the X-ray, or data collected by individual lines or segments of individual lines of pixels in an X-ray sensor.

The term “conveying means” refers to means for conveying item along a specific route. Such means include, but are not limited to, a conveyor, and may for example also include means such as a robotic arm, or other means that are appropriate for conveying items and are compatible with the present invention.

The term “linear segment” refers in the present context to a three-dimensional slice through an item, such as an item being conveyed along a conveyor and inspected for the presence of bones, bone fragments or other undesired materials. By using a linear X-ray sensor and appropriate X-ray emitter means, data corresponding to an image of the segment being inspected is obtained. The image data therefore will correspond to the slice through the conveyed item.

It is an object of a preferred embodiment of the present invention to provide an apparatus for inspecting food items. Accordingly, the present invention, in a first aspect, relates to an apparatus for inspecting food items, the apparatus comprising
conveying means for conveying food items in a predetermined direction;
means for generating uniform X-ray attenuation image of said food items, further comprising:
   means for forming the food items into a shape of uniform thickness;
   X-ray emitting means, for emitting X-rays through said food items as they are conveyed by said conveyor through said means for forming the food items;
   X-ray sensing means, for collecting X-rays after penetrating through said food items as they are conveyed by said conveyor through said means for forming the food items;
processing means,
wherein said processing means is adapted to store and/or process X-ray image data.

The apparatus may in one embodiment further comprise means for registering the nature, location and quantity of observed bones, bone fragments or other undesired materials in the food items.

In another embodiment, the apparatus may further comprise means for registering which food items, or which part of the food stream, contain such artifacts, and means for using this information to make decisions on further action on the food material, such as routing or removing the food accordingly.

A controlling unit, which is part of the processing means of the apparatus, or is linked to the processing means of the apparatus, can be used to register and process the information. The same controlling unit can be linked to means for routing, removing or otherwise processing the food items determined to contain undesired materials. Such means can be comprised of displacement means, conveyors and/or other means known to those skilled in the art.

The emitted X-rays may be of any suitable energy levels for the particular use The X-ray sensor may in one embodiment be adapted to receive an X-ray beam in an approximately perpendicular direction with respect to the conveying direction. In another embodiment, the X-ray sensor may be adapted to receive an X-ray beam at an angle with respect to the conveying direction. The location of inspection of the conveyed food item may be carefully controlled, such that only one linear segment of the food item, defined by the path from the x-ray emitter to a linear or rectangular x-ray sensor, is analyzed at any given time. The sensor may be any X-ray sensor known to those skilled in the art, such as a film sheet, a linear sensor, an image intensifier or a flat panel sensor, or other alternative means for sensing X-rays. The X-ray sensor may in alternative embodiments be comprised of an array of sensor pixels of any suitable geometry, such as an arc-shaped geometry or a zig-zag geometry.

The position of the X-ray emitter can be adjusted so that an X-ray beam penetrates the food item at any given location, as the item passes through the means for forming the food items into a shape of substantially uniform thickness. For example, the X-ray emitter may be adjusted to be located over or under the center of the means for forming the food items into a shape of substantially uniform thickness, so that the X-ray beam passes through the formed food items directly underneath or above the emitter, in the center of the means for forming the food items into a shape of substantially uniform thickness. However, other embodiments of the apparatus, in which the location of the X-ray emitter with respect to the food item as the X-ray beam passes through the means for forming the food items into a shape of substantially uniform thickness, are possible. For example, it may be advantageous to offset the location of the X-ray emitter slightly, so that the X-ray beam passes through the food item just before or just after passing through the narrowest part of the means for forming the food items into a shape of substantially uniform thickness.

In yet another embodiment, the X-ray emitter and the X-ray sensor are positioned at an angle with respect to the conveying direction, such that a slice or segment of the food item being inspected at any given time represents a diagonal slice or segment through the item. In general, the given embodiment most advantageous will in general depend on several factors including the composition of the food product, the specific embodiment of the means for forming the food items into a shape of substantially uniform thickness, and the size and/or distribution of expected bones, bone fragments or other items that may be present in the food items.

The X-ray beam delivered by the X-ray emitter may either be a collimated X-ray beam, or an un-collimated X-ray beam.

In one embodiment of the invention X-rays to pass through the means for forming the food items into a shape of substantially uniform thickness as well as the food items. Thus, emitted X-rays may pass through the means for forming the food items into a shape of substantially uniform thickness prior to or after passing through the food items. In such an embodiment the X-ray emitter is positioned above or below the conveyed food items such that the X-ray beam, passes through the means for forming the food items into a shape of substantially uniform thickness before passing through the formed food items and enter the X-ray sensor. Other embodiments of the inventions, in which the location of the X-ray emitter with respect to the conveying means and the means for forming the food items into a shape of substantially uniform thickness are different are also possible, such as an embodiment in which the location of the X-ray emitter and the X-ray sensor is reversed, i.e. the X-ray emitter is located under the conveying means, and the X-ray sensor above conveying means and the means for forming the food items into a shape of substantially uniform thickness.

The means for forming the food items into a shape of substantially uniform thickness will in general be positioned in proximity to the conveying means, perpendicular to the conveying plane. Thus, in the case when a conveyor is used to convey the food items, the means for forming the food items into a shape of substantially uniform thickness will be positioned in proximity to the conveyor, perpendicular to the plane of the conveyor. In one embodiment, the means for forming the food items into a shape of substantially uniform thickness is positioned in a perpendicular fashion above the plane of the conveyor.

The means for forming the food items into a shape of substantially uniform thickness may in one embodiment apply pressure to form a continuous segment of food items at angle to, or approximately perpendicular to, the conveying direction of a conveyor. The segment may be straight, in which case an approximately linear segment of food items is formed at any given time. The segment may also be bent or of any other shape suitable for the given embodiment. In one embodiment, the X-ray sensor means comprises means for detecting at least a linear segment of formed food items, which corresponds to the segment formed by applying pressure to the surface of the food item.

The distance between the means for forming the food items into a shape of substantially uniform thickness and the conveying means, for example the conveyor on which food items are conveyed, is varied to suit the particular food items being conveyed. Thus, the distance, which is approximately perpendicular to the plane of the conveyor, can be in the range of about 0.1-10 cm, such as about 0.2-6 cm, such as about 0.3-5 cm, such as about 0.4-4 cm, including about 0.2-3 cm. In general, the distance will be chosen such that the food items passing through the means for forming the food items into a shape of substantially uniform thickness will be formed by applied pressure, and thus in general the distance will be smaller than the thickness of the food items conveyed through the apparatus of the invention.

The means for forming the food items into a shape of substantially uniform thickness can be constructed in any manner that ensures relatively uniform thickness of the conveyed item. Advantageously, the means for forming the food items into a shape of substantially uniform thickness doesn't significantly slow down or impede the movement of the conveyed items. Thus, in one embodiment, the means for forming the food items into a shape of substantially uniform thickness is comprised of a first roller approximately parallel to the conveying plane, wherein the roller is able to rotate freely or alternatively is driven by a motor, the speed of which is synchronized with the speed of the conveying means. In such an embodiment, the speed of the conveying means determine the overall throughput of the apparatus of the invention. In one embodiment, the first roller is positioned approximately perpendicular to the conveying direction. In another embodiment, the first roller may be positioned at an angle with respect to the conveying direction.

In another embodiment of the invention, the means for forming the food items into a shape of substantially uniform thickness further comprises a belt which is stretched across the roller, and is positioned in between the roller and the conveying means, and wherein the belt is stretched at a fixed angle with respect to the conveying means. The angle between the conveying means and the belt may be in the range of about 0°-90°, such as about 5°-80°, such as about 10°-50°, including about 10°-40°. However, the angle between the conveying means and the belt may not be identical on both sides of the roller. Thus, in some embodiments it may be appropriate to have the belt positioned such that the angle towards the upstream end of the conveying means is different from the angle towards the downstream end. The belt aids in the transport and forming of the conveyed food items, such that the items are gradually compressed while moving through the means for forming the food items into a shape of substantially uniform thickness, first by the belt alone, and as they move under the roller, by the combined action of the roller and the belt.

The means for forming the food items into a shape of substantially uniform thickness may in another embodiment further comprise a second roller, wherein the two rollers are oriented in a parallel fashion on either side of an X-ray sensor, and wherein the belt presses onto the food items as they are conveyed through the X-ray beam. The rollers may be positioned perpendicular to the conveying direction, or alternatively at an angle to the conveying direction.

In such embodiments, the area compressing the food items is increased, which means that the entire food items may simultaneously be formed, rather than one section at a time. Furthermore, depending on the spacing of the two rollers, several food items may be simultaneously compressed. Such embodiments allow for the inspection of several items simultaneously, for example by using an X-ray emitter delivering X-rays over the area of interest containing formed food items, and an X-ray sensor that detects transmitted X-rays in the area.

In yet another embodiment, additional rollers may be present, for aiding in the compression of items moving through the means for forming the food items into a shape of substantially uniform thickness.

The distance between the means for forming the food items into a shape of substantially uniform thickness and the conveying means determines the thickness of the conveyed food items under pressure. In one embodiment, the first roller and/or second roller or alternatively any further rollers, are mounted at a fixed distance from the conveying means, such that a constant thickness of formed food items in between the roller and the conveying means is obtained as the items pass through the means for forming the food items into a shape of substantially uniform thickness.

In another embodiment, the first roller and/or second roller or any additional rollers, are mounted on a mechanism for allowing variations in the distance between the conveying means and the roller as the food items passes under the roller. The mechanism for allowing variations may in one embodiment be a spring mechanism. Such embodiments allow for some degree of tolerance with respect to large differences in thickness or composition of conveyed food items. Thus, if a food item has large inherent variations in thickness, it may be necessary to allow the means for forming the food items into a shape of substantially uniform thickness to adjust to the changes in thickness, by for example applying a constant pressure delivered by a spring mechanism. Alternatively, the pressure may be controlled by electromechanical means such as a motor, fluid pressure, or other means. Such mechanism may also be necessary if the conveyed items contain a large bone or other items which could impede or slow down the movement of the item, through the means for forming the food items into a shape of substantially uniform thickness, in the absence of means for allowing some variations in the distance between the conveying means and the means for forming the food items into a shape of substantially uniform thickness.

As an alternative or in addition to a spring mechanism to allow for tolerance in the raw material thickness, the conveying belt may be used for the same purpose. By introducing a gap in the surface supporting the conveying belt, it will yield to pressure. This gap would typically be elongated and located in the path of the X-rays emitted from the source to the sensor. The gap may be abrupt, with an opening of a fixed width. Alternatively, it may have a gradual opening. In either case, the conveyor belt is pressed into the gap and the amount of indentation is controlled with factors such as the gap geometry, belt tension and mechanical properties of the belt.

Thus, in yet another embodiment of the invention, the conveying means are comprised of a conveyor, and a recess or a gap in the conveyor support is provided, such that the distance between the conveying surface and the means for forming the food items into a shape of substantially uniform thickness can be varied by varying the depth, length and/or width of the recess, and the tension in the belt. In such an embodiment, large items can be accommodated by having the recess and/or gap dimensions comparable to, or even larger than, the size of the conveyed items, and the tension of the belt is adjusted so that the conveyed items can pass through the means for forming the food items into a shape of substantially uniform thickness along the conveyor. The relative dimensions of the recess and/or gap and the tension of the belt can however be varied so as to suit any specific embodiment, and such variations will be apparent to those skilled in the art.

A variety of rollers are compatible with the present invention, with respect to size, relative dimensions and composition. In one embodiment, the first roller and/or second roller or any additional rollers may be comprised of a hollow cylinder, while in other embodiments the rollers are comprised of a solid cylinder which may be comprised of a uniform mass of material, or they may alternatively contain a core comprising one or several materials, and a different material at their outer surface.

In another embodiment, the means for forming the food items into a shape of substantially uniform thickness is comprised of a stationary guide. The stationary guide, which may be positioned approximately perpendicular to, or at an angle to, the conveying means, may be comprised of an elongated member which can be flat, or alternatively has an overall convex shape in the conveying direction, as seen from the conveying means. This means that a cross-section of the stationary guide will in this embodiment have a convex shape. The degree of curvature can be varied depending on the application. A highly curved stationary guide will exert an effect similar to a roller of a small diameter, while guides with a small curvature may be advantageous when a gradual forming of the conveyed food items is desirable, for example to minimize the chance of jamming or blocking the flow of food material.

In another embodiment, a belt is stretched under the stationary guide, at an angle with respect to the conveying direction. The angle between the conveying means and the belt may be in the range of about 0°-90°, such as about 5°-80°, such as about 10°-50°, including about 10°-40°. However, the angle between the conveying means and the belt may not be identical on both sides of the stationary guide.

The stationary guide may in one embodiment be mounted on a mechanism for allowing variations in the distance between the conveying means and the roller as the food items passes under the roller. Such mechanism may for example be comprised of a spring mechanism. In such an embodiment, some degree of tolerance with respect to large differences in thickness or composition of conveyed food items is allowed. Thus, if a food item has large inherent variations in thickness, it may be necessary to allow the stationary guide to adjust to the changes in thickness, by for example applying a constant force delivered by a spring mechanism. Alternatively, the force may be controlled by electromechanical means such as a motor, fluid pressure, or other means. Such mechanism may also be necessary if the conveyed items contain a large bone or other items which could impede or slow down the movement of the item through the stationary guide in the absence of means for allowing some variations in the distance between the conveying means and the means for forming the food items into a shape of substantially uniform thickness. The stationary guide may further in an alternative embodiment comprise a perforation along its longitudinal axis, during which emitted X-rays pass.

The material used in the means for forming the food items into a shape of substantially uniform thickness is advantageously a material that allows X-rays to penetrate the material. Thus, in one embodiment, the means for forming the food items into a shape of substantially uniform thickness is comprised of a material such as a plastic material that allows essentially full permeation of radiation from the X-ray emitter.

In an alternative embodiment, the means for forming the food items into a shape of substantially uniform thickness are comprised of a material that modifies the emitted spectrum of X-rays in a predetermined manner, thus serving as an X-ray filter. Such embodiments may be advantageous if the inspection of food items benefits from selected X-ray energies being used in the analysis, and may easily be realized by constructing the means for forming the food items into a shape of substantially uniform thickness, such as the rollers and/or the stationary guide, from suitable materials.

In yet another embodiment, the apparatus of the invention comprises a controller for adjusting the amount of pressure exerted by the means for forming the food items into a shape of substantially uniform thickness. Such adjustment may for example be based on analysis of the surface height of the food items prior to X-ray imaging. Such analysis, which may be a three-dimensional analysis of the surface, can be performed by means known in the art, such as conventional imaging using visible light, or by imaging using ultrasound techniques.

In a further embodiment, the apparatus comprises a force sensor for sensing the force of the applied pressure, said force sensor being functionally linked to the controller for adjusting the amount of pressure exerted by the means for forming the food items into a shape of substantially uniform thickness. The amount of pressure may for example be adjusted in real-time, based on the thickness determined from X-ray data collected from the formed food items as they pass through the X-ray beam.

By applying data collected by force sensors, it is possible to adjust the pressure exerted by the means for forming the food items into a shape of substantially uniform thickness, so as to obtain the desired degree of uniformity in the forming procedure. Also, be utilizing such means, it is possible to analyze food items of variable composition or origin, and which may therefore have different compressibility. Further, adjustment of the applied force by the means for forming the food items into a shape of substantially uniform thickness can be important for applications in which uniform thickness of the food items is of great importance for the analysis.

The distance between the means for forming the food items into a shape of substantially uniform thickness and the conveying means on which the food items are placed controls the maximum thickness of the food items as it is scanned. Thus, in an alternative embodiment of the invention, knowledge of this maximum thickness can be used in the process of collecting X-ray image data and processing it, for example, in controlling the X-ray emitter parameters, scanning parameters, or in selecting intensity thresholds for the image.

In a second aspect, the present invention relates to a method of inspecting food items for the presence of bones, bone fragments or undesired materials, the method comprising the steps of:
conveying food items along conveying means in a predetermined direction;
means for generating uniform X-ray attenuation image of said food items by forming said food items into a shape of uniform thickness;
emitting X-rays through said food items as they are conveyed by said conveyor through said means for forming the food items;
generating X-ray image from collecting attenuated X-rays after penetrating through at least one segment of said food items as they are conveyed by said conveyor through said means for forming said food items;
image processing and analyzing of the generated X-ray image,
   wherein said image processing and analysis of the X-ray image data determines if any of said segments of food items contains bones, bone fragments or other undesired material.

The means for forming the food items into a shape of substantially uniform thickness may in one embodiment be adapted to form a continuous segment of food items at angle to, or approximately perpendicular to, the conveying direction of a conveyor. The segment may be straight, in which case an approximately linear segment of food items is formed at any given time by applying pressure to the means for forming the food items into a shape of substantially uniform thickness. The segment may also be bent or of any other shape suitable for the given embodiment. In one embodiment, the X-ray sensor means comprises means for detecting at least a linear segment of formed food items, which corresponds to the segment formed by the means for forming the food items into a shape of substantially uniform thickness.

The method may be applied to any food item, such as boneless or de-boned food items.

Items that are determined to contain bones or bone fragment are advantageously removed from the conveying means. Thus, in one embodiment, the method further comprises removing food items determined to contain bones or bone fragments from the conveying means by means of a displacement mechanism. Items may be displaced into a receiving bin, onto conveying means such as a conveyor, or into a processing line, where further processing of identified food items may take place. Other means for displacing items and various receiving means suitable for various applications and/or processing known to those skilled in the art are possible for this purpose, and such means are also within the scope of the invention.

In another embodiment, the apparatus of the invention further comprises means for registering the location of items determined to contain bones, bone fragments or other undesired material for further processing or action.

Other embodiments of the apparatus of the invention, as disclosed in the above, can suitably be adapted for use in the method of the invention, for inspecting food items for the presence of bones, bone fragments or other undesired materials.

In a further aspect, the present invention relates to the use of an X-ray apparatus in the detection of bones, bone fragments or other undesirable materials in food items, said use comprising obtaining an X-ray image of at least a segment of the food items while conveyed on a conveying means, said food items being simultaneously formed along at least a segment by means of a forming mechanism, such that X-ray image data of at least a segment of food items of substantially uniform thickness is obtained, and wherein image analysis of the acquired X-ray image data is used to determine if bones or bone fragments are present in the food items.

In one embodiment, a continuous segment of food items is formed at an angle to, or approximately perpendicular to, the conveying direction of a conveyor. The segment may be straight, in which case an approximately linear segment of food items is formed at any given time. The segment may also be bent or of any other shape suitable for the given embodiment. In one embodiment, the X-ray sensor means comprises means for detecting at least a linear segment of formed food items, which corresponds to the segment formed by the means for forming the food items into a shape of substantially uniform thickness.

The X-ray data may be data that represents complete, processed and stored images of food items. Alternatively, the data may represent image fragments, individual lines of image data obtained by means of a linear array of sensor pixels. The data may also either represent real-time data that has not been stored or processed, or recorded and processed data.

As discussed in the above, the image analysis of the at least linear segment can be performed either along the at least linear segment of the food item which undergoes greatest degree of forming by the means for forming the food items into a shape of substantially uniform thickness, or alternatively, adjacent to the area.

Although the present invention has been described in the context of analysis for the detection of bones, bone fragments or other undesired material, the detection or measurement of other properties of food items, such as fat content or internal structure, can be enhanced by the apparatus and method of the present invention. In general, measurement or imaging methods and/or apparatus that benefit from a substantially uniform thickness of the inspected item will benefit by the present invention.

### DETAILED DESCRIPTION OF THE INVENTION

In the following, the present invention will be described in more detail, referring to the drawings, in which

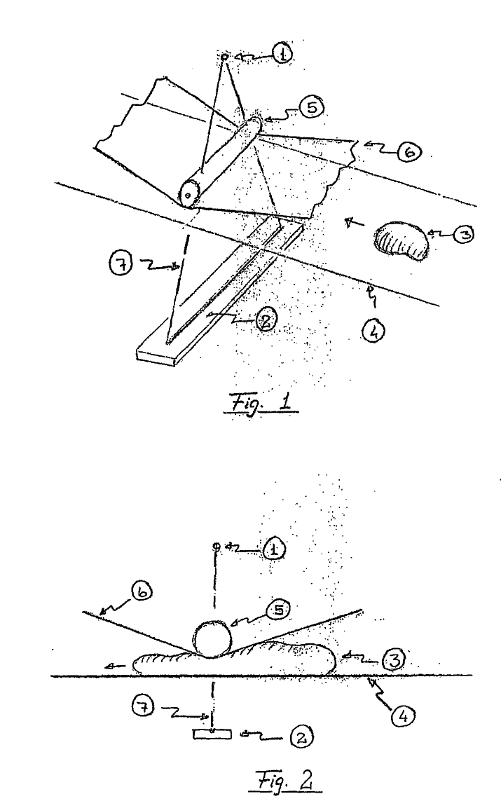

FIG. 1 shows an overview of the setup of one embodiment of the invention showing an X-ray emitter, an X-ray sensor and means for forming the food items into a shape of substantially uniform thickness comprised of a roller under which a belt has been stretched;

FIG. 2 shows a side view of one embodiment, viewed along the roller axis and indicating how the conveyed food items are formed by the means for forming the food items into a shape of substantially uniform thickness while being conveyed;

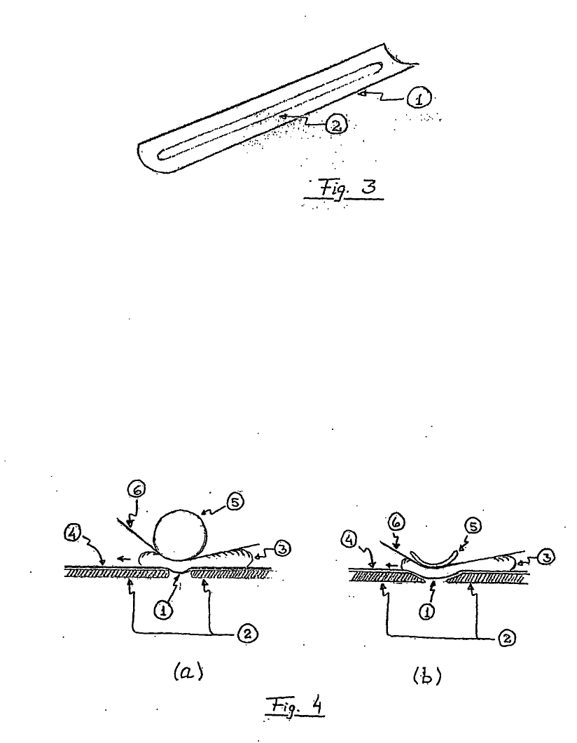

FIG. 3 shows one alternative embodiment of the means for forming the food items into a shape of substantially uniform thickness comprising a stationary guide, which is used for pressing the conveyed food items and replaces the roller;

FIG. 4 shows a side view of an embodiment in which a gap or recess in the conveyor allows tolerance in the thickness of the conveyed food items.

In one preferred embodiment of the invention, shown in FIG. 1, a food item 3 is conveyed along a conveyor 4 in a predetermined direction which is indicated by the arrow. A stretching means is comprised of a roller 5, under which a belt 6 is stretched at an angle with respect to the conveyor 4. An X-ray emitter 1 is positioned above the means for forming the food items into a shape of substantially uniform thickness 5,6, and emits an X-ray beam 7. A linear X-ray sensor 2, for example a sensor comprising a linear array of sensor pixels, detects transmitted X-rays, which have permeated the means for forming the food items into a shape of substantially uniform thickness 5,6 and any food items passing through the means for forming the food items into a shape of substantially uniform thickness.

A side view is shown in FIG. 2, in which a food item 3 is passing through the means for forming the food items into a shape of substantially uniform thickness 5,6. The combined action of the roller 5 and the belt 6 receives the conveyed food item and forces the item to be formed to an substantially uniform thickness as the item passes under the means for forming the food items into a shape of substantially uniform thickness, the thickness being given by the distance between the roller 5 and the conveyor 4. In this embodiment, a linear X-ray beam 7 is emitted by the X-ray emitter 1, passing through the roller 5 and belt 6, before permeating the food item 3. The linear X-ray sensor 2 detects transmitted X-rays, and subsequent image analysis of the transmitted X-rays is used to determine, whether unexpected X-ray absorption due to foreign items such as bones or bone fragments, are present in the food item.

One alternative embodiment of the means for forming the food items into a shape of substantially uniform thickness is shown in FIG. 3. In this embodiment, the means for forming the food items into a shape of substantially uniform thickness is comprised of an elongated stationary guide, which may replace the roller, and can be used with or without an accompanying belt. The stationary guide is typically comprised of a thin material which is readily permeated by X-rays. However, the stationary guide may alternatively comprise a linear perforation 2, through which the X-ray beam 7 passes. In such an embodiment, the stationary guide may be comprised of any suitable material, which does not need to be permeable to X-rays.

FIG. 4 provides a side view of an alternative embodiment of the invention. Tolerance in the thickness of conveyed food items is allowed by the introduction of a recess or gap 1 in the conveyor support 2, such that the conveyor belt 4 forms a recess into the recess or gap. This way, conveyed items 3 that are conveyed along the conveyor belt 4 will be conveyed through the means for forming the food items into a shape of substantially uniform thickness 5,6, and the recess provided in the conveyor support allows items of varying thickness to pass through.

FIG. 4a shows one embodiment, in which the supporting back surfaces 2 for the conveyor belt 4 are separated by a rectangular gap 1. Items 3 conveyed along the conveyor are, together with the conveyor belt, pressed into the gap 1 as the items pass through the means for forming the food items into a shape of substantially uniform thickness, which in this particular embodiment are comprised of a roller 5 and belt 6.

FIG. 4b shows an alternative embodiment in which the supporting back surfaces are separated by a trapezoidal gap in the support, and the means for forming the food items into a shape of substantially uniform thickness are comprised of a guide 5 and belt 6. It should be appreciated that all combinations of the different means for forming the food items as discussed herein, and the different possibilities for forming a gap or recess in the conveyor support to allow variations in the thickness of items are possible, and are also within the scope of the invention.

1. An apparatus for inspecting food items, the apparatus comprising:
conveying means for conveying food items in a predetermined direction;
means for generating uniform X-ray attenuation image of said food items, further comprising:
means for forming the food items into a shape of substantially uniform thickness;
X-ray emitting means, for emitting X-rays through said food items as they are conveyed by said conveyor through said means for forming the food items;
X-ray sensing means, for collecting X-rays after penetrating through said food items as they are conveyed by said conveyor through said means for forming the food items;
processing means,
wherein said processing means is adapted to store and/or process X-ray image data.

2. The apparatus according to claim 1, wherein the means for generating an uniform X-Ray attenuation image is adapted to:
form at least a linear segment of said food items into a shape of uniform thickness,
and wherein the X-ray sensing means comprises means for detecting at least a linear segment of X-rays penetrating through said food items,
wherein said linear segment of said food items is formed into a shape of uniform thickness.

3. The apparatus according to claim 1, wherein the X-ray sensing means are selected from the group consisting of a film sheet, a linear sensor, an image intensifier and a flat panel sensor.

4. The apparatus according to claim 1, wherein the means for forming the food items are adapted to allow X-rays to pass through the means for forming the food items into a shape of substantially uniform thickness as well as the formed food items.

5. The apparatus according to claim 1, wherein the means for forming the food items comprises:
a first roller,
wherein the first roller is able to rotate freely, or is alternatively, driven by a motor which speed is synchronized with the speed of the conveying means.

6. The apparatus according to claim 5, wherein the first roller is positioned substantially perpendicular to the conveying direction.

7. The apparatus according to claim 5, wherein the means for forming the food items further comprises:
an endless belt which is positioned in between the first roller and the conveying means,
wherein the belt is stretched at a fixed angle with respect to the conveying means.

8. The apparatus according to claim 7, wherein the angle between the conveying means and the belt is in the range of about 0°-90°, such as about 5°-80°, such as about 10°-50°, including about 10°-40°.

9. The apparatus according to claim 5, wherein the means for forming the food items further comprises:
a second roller,
wherein the first roller and the second roller are oriented in a parallel fashion on either side of said X-ray sensor, and wherein said endless belt presses onto the food items as they are conveyed through the X-ray beam.

10. The apparatus according to claim 5, wherein the first and/or second roller is mounted at a fixed distance from the conveying means, such that a substantially uniform thickness of formed food items in between the roller and the conveying means is obtained as the items pass through said means for generating uniform X-ray attenuation image of said food items.

11. The apparatus according to claim 5, wherein said first roller and/or said second roller is mounted on a mechanism for allowing variations in the distance between the conveying means and the roller as the food items passes under the roller.

12. The apparatus according to claim 11, wherein the first and/or second roller is mounted on a spring mechanism.

13. The apparatus according to claim 5, wherein said first roller and/or said second roller is comprised of a hollow cylinder.

14. The apparatus according to claim 1, wherein the means for forming the food items are comprised of a stationary guide.

15. The apparatus according to claim 14, wherein said stationary guide comprises an elongated member with an overall convex shape in the conveying direction, as seen from the conveying means.

16. The apparatus according to claim 14, wherein said stationary guide is mounted on a mechanism for allowing variations in the distance between the conveying means and the roller as the food items passes under the roller.

17. The apparatus according to claim 14, wherein said stationary guide is mounted on a spring mechanism.

18. The apparatus according to claim 5, wherein said means for forming the food items are comprised of a material such as a plastic material, that allows essentially full permeation of radiation from the X-ray emitter.

19. The apparatus according to claim 5, wherein said means for forming the food items are comprised of a material that modifies the emitted spectrum of X-rays in a predetermined manner, thus serving as an X-ray filter.

20. The apparatus according to claim 14, wherein said stationary guide comprises a perforation along its longitudinal axis, during which emitted X-rays pass.

21. The apparatus according to claim 1, further comprising a controller for adjusting the amount of pressure exerted by said means for forming the food items.

22. The apparatus according to claim 21, wherein said adjustment is based on analysis of the surface height of the food items prior to X-ray imaging.

23. The apparatus according to claim 21, further comprising a force sensor for sensing the force of the applied pressure, said force sensor being functionally linked to the controller for adjusting the amount of pressure exerted by said means for forming said food items.

24. The apparatus according to claim 21, wherein the amount of pressure is adjusted in real-time, based on the degree of compression determined from X-ray data collected from the compressed food items as they pass through the X-ray beam.

25. The apparatus according to claim 1, further comprising means for registering the nature, location and quantity of observed bones, bone fragments or other undesired materials in said food items.

26. The apparatus according to claim 1, further comprising:
means for registering which food items, or which part of the food stream, contain bones, bone fragments or other undesired materials, and
means for using this information to make decision on further action on the food material,
wherein such decision may involve routing or removing said food items accordingly.

27. The apparatus according to claim 1, wherein the conveying means are comprised of a conveyor wherein a recess or a gap in the conveyor support is provided, such that the distance between the conveying surface and the means for forming the food items can be varied by varying the depth, length and/or width of the recess, and the tension of said endless belt.

28. A method for inspecting food items for the presence of bones, bone fragments or other undesired material, the method comprising the steps of:
conveying food items along conveying means in a predetermined direction;
means for generating uniform X-ray attenuation image of said food items by forming said food items into a shape of uniform thickness;
emitting X-rays through said food items as they are conveyed by said conveyor through said means for forming the food items;
generating X-ray image from collecting attenuated X-rays after penetrating through at least one segment of said food items as they are conveyed by said conveyor through said means for forming said food items;
image processing and analyzing of the generated X-ray image,
wherein said image processing and analysis of the X-ray image data determines if any of said segments of food items contains bones, bone fragments or other undesired material.

29. The method according to claim 28, wherein the food items are de-boned food items.

30. The method according to claim 28, further comprising removing food items determined to contain bones, bone fragments or undesirable material from the conveying means into a receiving means by means of a displacement mechanism.

31. The method according to claim 30, wherein the receiving is selected from the group consisting of a receiving bin, a conveyor and a processing line.

32. The method according to claim 28, further comprising sending an alarm signal when bones, bone fragments or other undesired materials are detected.

33. Use of an X-ray apparatus in the detection of bones, bone fragments or other undesired materials in food items, said use comprising:
obtaining an X-ray image of at least one segment of the food items while conveyed on a conveying means,
wherein at least a segment of said food items are simultaneously formed into a shape of uniform thickness, such that a X-ray image data of at least a segment of food items of substantially uniform thickness is obtained, and wherein image analysis of the acquired X-ray image data is used to determine if bones, bone fragments or other undesired material are present in the food items.

34. The use according to claim 33, further comprising sending an alarm signal when image analysis of X-ray images identifies bones, bone fragments or other undesired material in the food items.
